(19) United States
(12) Patent Application Publication
(10) Pub. No.: US 2005/0015502 A1
(43) Pub. Date: Jan. 20, 2005

(54) Method for communicating data between client and server using RDT messages, recording medium, system, user agent client, and user agent server thereof

(75) Inventors: Chun-un Kang, Seoul (KR); Lye-suk Lee, Seoul (KR); Jae-sung Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/851,097

(22) Filed: May 24, 2004

(30) Foreign Application Priority Data
May 23, 2003 (KR) 2003-32881

(51) Int. Cl. G06F 15/16

(52) U.S. Cl. 709/228

(57) ABSTRACT

A data communication method using an RDT (Reliable Data Transfer) message as an expanded SIP, a recording medium, a system, a client (UAC), and a server (UAS). The data communication method includes: (a) initializing a communication session using Session Initiation Protocol (SIP); (b) requesting the server for using a Reliable Data Transfer (RDT) message as an expanded SIP, receiving data, and checking whether the data is correctly received; and (c) terminating the communication session using SIP.

### BACKGROUND OF THE INVENTION

This application claims priority from Korean Patent Application No. 2003-32881, filed on May 23, 2003, in the Korean Intellectual Property Office, the disclosure of which is incorporated herein in its entirety by reference.

1. Field of the Invention

The present invention relates to a system and method for communicating data between a client and a server via wired or wireless services, and more particularly, to a system and method for communicating data between a client and a server using Reliable Data Transfer (RDT) messages as an, expanded Session Initiation Protocol (SIP).

2. Description of the Related Art

Conventional mobile communication devices have used a Simple Message System (SMS) for electronic commerce of digital content. SMS transmits data at a maximum rate of 150 BPS (bytes per second) between terminals or between a terminal and a server, so that messages consisting of characters or figures can be communicated. Such an SMS service includes short-message transmission, urgent-message marking, date/time recording, message recognition, etc.

However, since SMS is a unidirectional message system, SMS includes no device for checking whether data is completely transmitted and whether transmitted data is correct. Furthermore, a service-fee for data transmission is paid prior to the data transmission. As a result, when conducting electronic commerce to purchase digital content using a conventional mobile communication device, a user may first pay a service-fee for data transmission and then not properly receive the data due to some kind of communication disturbance. Thus, the conventional SMS data service cannot ensure stable and reliable data transmission.

### SUMMARY OF THE INVENTION

The present invention provides a system and method for communicating data using Session Initiation Protocol (SIP) as a communication protocol constructing an New Generation Network (NGN), in order to ensure stable and reliable data transmission.

According to an aspect of the present invention, there is provided a method for communicating data between a client and a server, the method comprising: (a) initializing a communication session using Session Initiation Protocol (SIP); (b) requesting the server for data using a Reliable Data Transfer (RDT) message as an expanded SIP, receiving data, and checking whether the data is correctly received; and (c) terminating the communication session using SIP.

The step (b) comprises: (b1) receiving random data, sequential data, or encrypted data.

The step (b) further comprises: (b2) paying if all requested data is received and there are no errors in the received data.

The step (b1) comprises: (b1-1) transmitting a data transmission request including information on requested data to the server; and (b1-2) receiving a response from the server indicating whether the data transmission request is accepted. The step (b1) further comprises: (b1-3) transmitting information on a block, which is a unit of transmission data, of requested data to the server; and (b1-4) receiving block data corresponding to the information on the block together with error correction information from the server; and (b1-5) checking for errors in the received block data using the received error correction information, wherein steps (b1-3) through (b1-5) are repeated until the requested data is all received.

The step (b1) further comprises: (b1-6) transmitting summary error correction information for received block data to the server; and (b1-7) receiving information on the existence of errors in data checked using the summary error correction information, from the server.

The step (b1-4) further comprises receiving encrypted block data using any one among Advanced Encryption Standard (AES), Data Encryption Standard (DES), and scrambling.

According to another aspect of the present invention, there is provided a computer readable medium having embodied thereon a computer program for the data communication method.

According to another aspect of the present invention, there is provided a computer readable medium comprising: a Session Initiation Protocol (SIP) message, which includes an SIP header part required for initializing a session and an SIP body part capable of performing a desired function through a set session; and an RDT message, which includes a command representing a type of a command to be executed and at least one parameter with information required for executing the command, and is included in the SIP body part.

According to another aspect of the present invention, there is provided a system for communicating data between a client and a server, the system comprising: a user agent client (UAC), which requests desired data using a Reliable Data Transfer (RDT) message as an expanded Session Initiation Protocol (SIP) and checks whether the data is correctly received; and a user agent server (UAS), which combines the requested data with information indicating whether the data is correctly transmitted, using the RDT message as the expanded SIP, and transmits the resultant data.

The user agent client (UAC) which requests a server for data comprises: a Reliable Data Transfer (RDT) message processor which converts information on requested data into an RDT message and extracts the requested data from a received RDT message; a Session Initiation Protocol (SIP) stack which communicates an SIP message including an RDT message from/to the server; a data application unit which processes or stores the extracted data; and a data controller, which sends information on requested data to the RDT message processor and transfers a transformed RDT message to the SIP stack, and sends an RDT message received from the SIP stack to the RDT message processor and transfers information on the extracted data to the data application unit.

The user agent server (UAS) which provides data to a client, the server comprising: a Reliable Data Transfer (RDT) message processor which extracts information on requested data from a received RDT message, and transforms the information on requested data into an RDT message; a Session Initiation Protocol (SIP) stack which communicates an SIP message including an RDT message from/to the client; a data provider which provides data corresponding to the information on requested data to a data controller; and a data controller, which sends an RDT message received from the SIP stack to the RDT message processor and transfers information for the extracted data to the RDT message processor, and sends information on data received from the data provider to the data provider and transfers a transformed RDT message to the SIP stack.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are views for explaining a system that communicates data between a user agent client (UAC) and a user agent server (UAS), according to the present invention;

FIG. 2 is a flowchart illustrating a process for communicating data between a user agent client (UAC) and a user agent server (UAS), according to the present invention;

FIG. 3A is a flowchart illustrating a process for communicating random data;

FIG. 3B is a communication diagram representing the process of FIG. 3A;

FIG. 3C is a detailed flowchart illustrating a process for communicating random data;

FIG. 4A is a flowchart illustrating a process for communicating sequential data;

FIG. 4B is a communication diagram representing the process of FIG. 4A;

FIG. 5A is a flowchart illustrating a process for communicating encrypted data;

FIG. 5B is a communication diagram representing the process of FIG. 5B;

FIG. 6A is a flowchart illustrating a process that further includes a payment step after communicating data;

FIG. 6B is a communication diagram representing the process of FIG. 6A;

FIG. 7A is a flowchart illustrating a process that further includes a payment step after communicating encrypted data;

FIG. 7B is a communication diagram representing the process of FIG. 7A;

FIG. 8 is a conceptual scheme of a Reliable Data Transfer (RDT) message according to an OSI 7-layer model;

FIG. 9A is a block diagram of a user agent client (UAC) according to an exemplary embodiment of the present invention;

FIG. 9B is a block diagram of a user agent server (UAS) according to an exemplary embodiment of the present invention;

FIG. 10A is a view showing a conceptual configuration of an RDT message according to an exemplary embodiment of the present invention;

FIG. 10B is a view showing detailed configurations of RDT messages according to embodiments of the present invention; and

FIGS. 11A and 11B show RTD messages according to embodiments of the present invention.

### DETAILED DESCRIPTION OF THE INVENTION

Hereinafter, embodiments of the present invention will be described in detail with reference to the appended drawings.

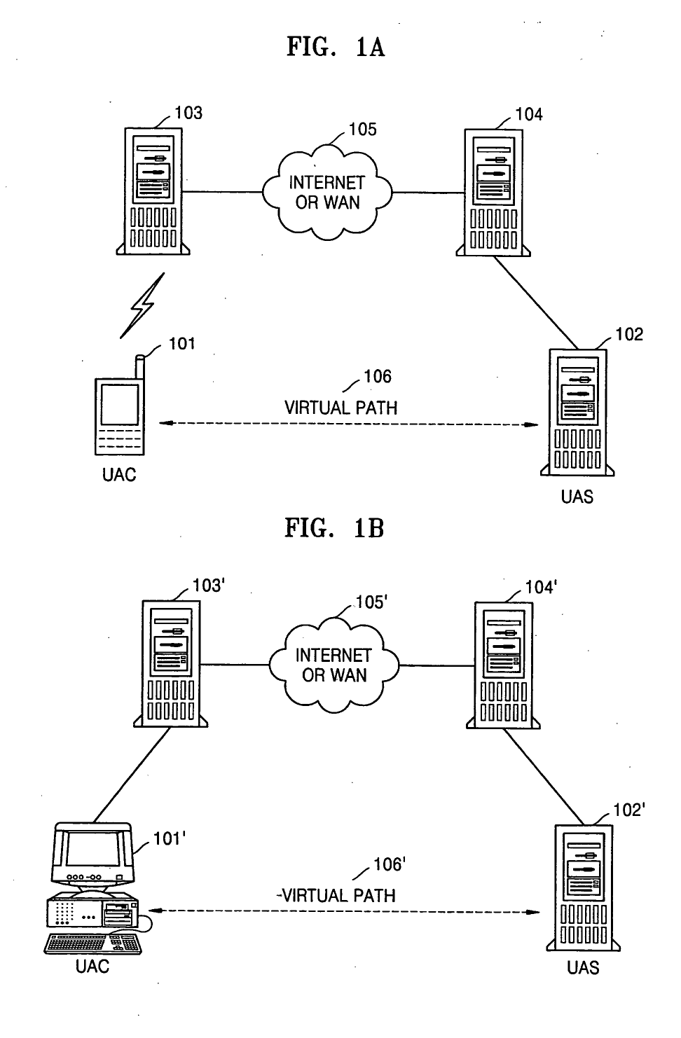

FIGS. 1A and 1B are views for explaining a system that communicates data between a user agent client (UAC) and a user agent server (UAS), according to the present invention.

Referring to FIG. 1A, a data communication system using Reliable Data Transfer (RDT) messages includes a User Agent Client (UAC) 101 and a User Agent Server (UAS) 102. The client (UAC) 101 is connected with the server (UAS) 102 through the Internet or WAN 105 via proxy servers 103 and 104.

Both terminals (client and server) communicate with each other using Session Initiation Protocol (SIP). SIP is a protocol developed for setting a session between VoIP terminals allowing speech communication, such as Internet telephones, PDAs, mobile phones, and the like. SIP, a text-based application layer protocol, supports P2P (Peer to Peer) communication between terminals so that two or more terminals can make, correct, and terminate a session. Accordingly, after initializing a session using SIP, the client (UAC) and the server (UAS) conduct P2P communication directly via a virtual path 106.

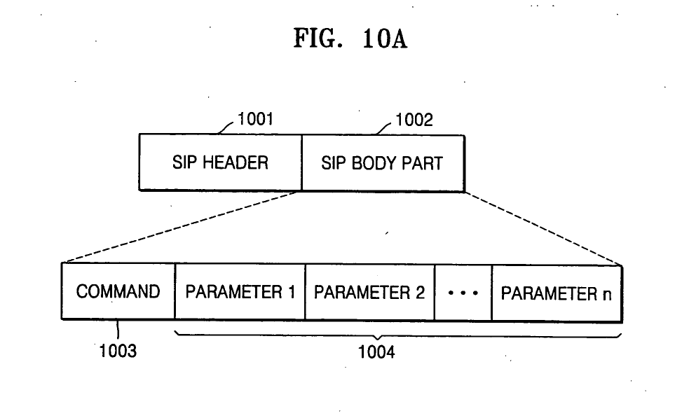

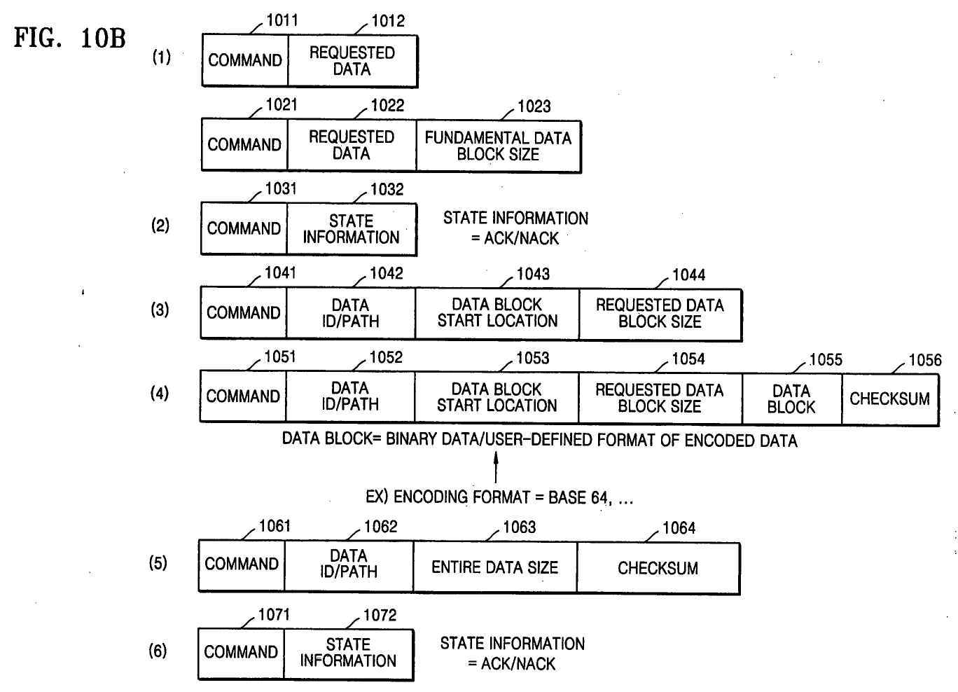

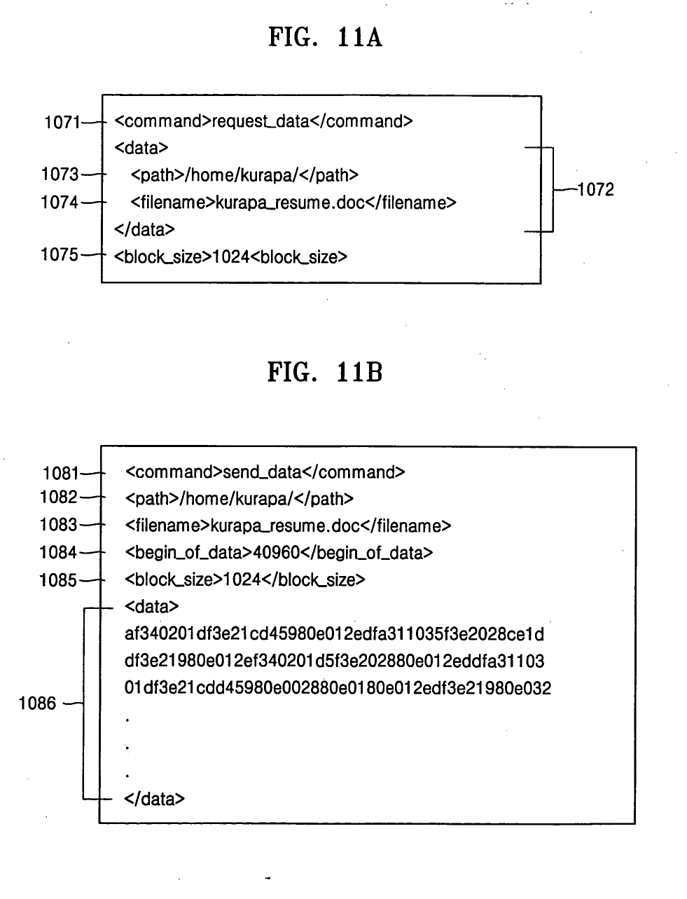

The RDT message is an expanded SIP according to the present invention, to which a function capable of increasing the reliability and stability of data transmission is added. The RDT message has all advantages provided by SIP, i.e., user mobility, minimal state maintenance, and independence for a lower layer protocol. Also, the RDT message is a text-based protocol like HTTP. The RDT message will be described later in detail (with reference to FIGS. 10 and 11).

The client (UAC) 101 requests desired data using an RDT message and checks whether the requested data is correctly received. The client (UAC) 101 may be any of various terminals with a communication function supporting SIP and RDT messages, such as an Internet telephone, a PDA, a mobile phone, or a PC.

The server (UAS) 102 combines the requested data with information capable of determining whether data is correctly transmitted, using an RDT message, and transmits the resultant data. The server (UAS) 102 can perform at least one function among electronic commerce, contents distribution, Data-warehousing, and electronic documents management.

FIG. 1B shows a data communication system that has the same construction as shown in FIG. 1A, except that a client (UAC) 101′ is connected to a proxy server 103′ through a wire.

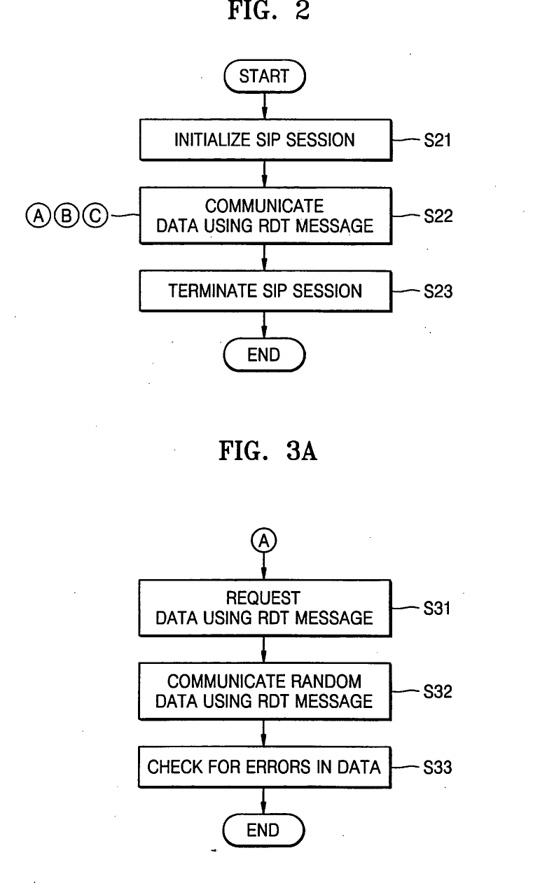

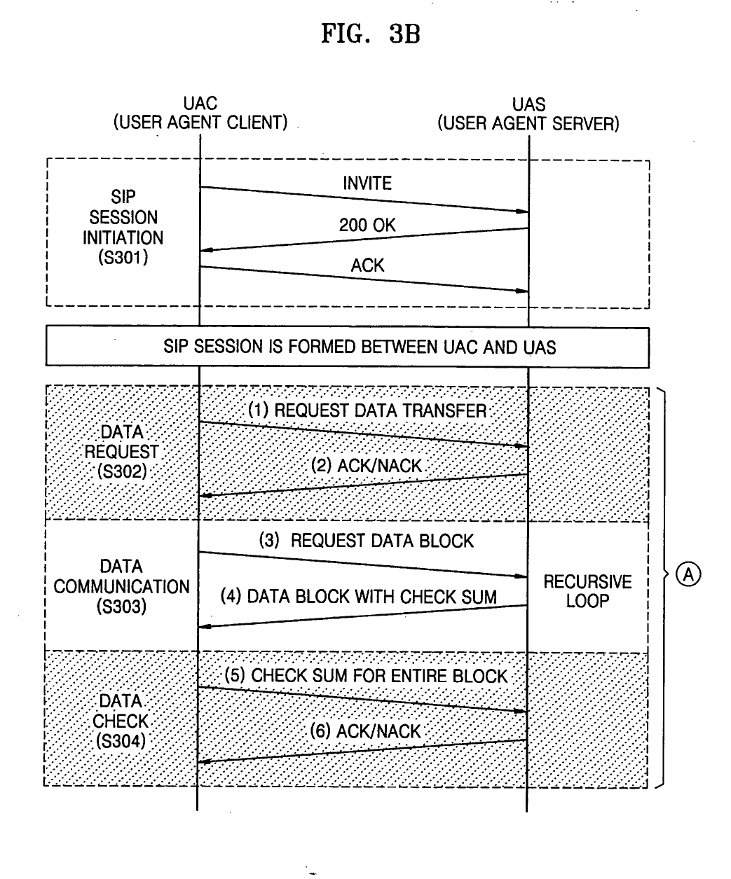

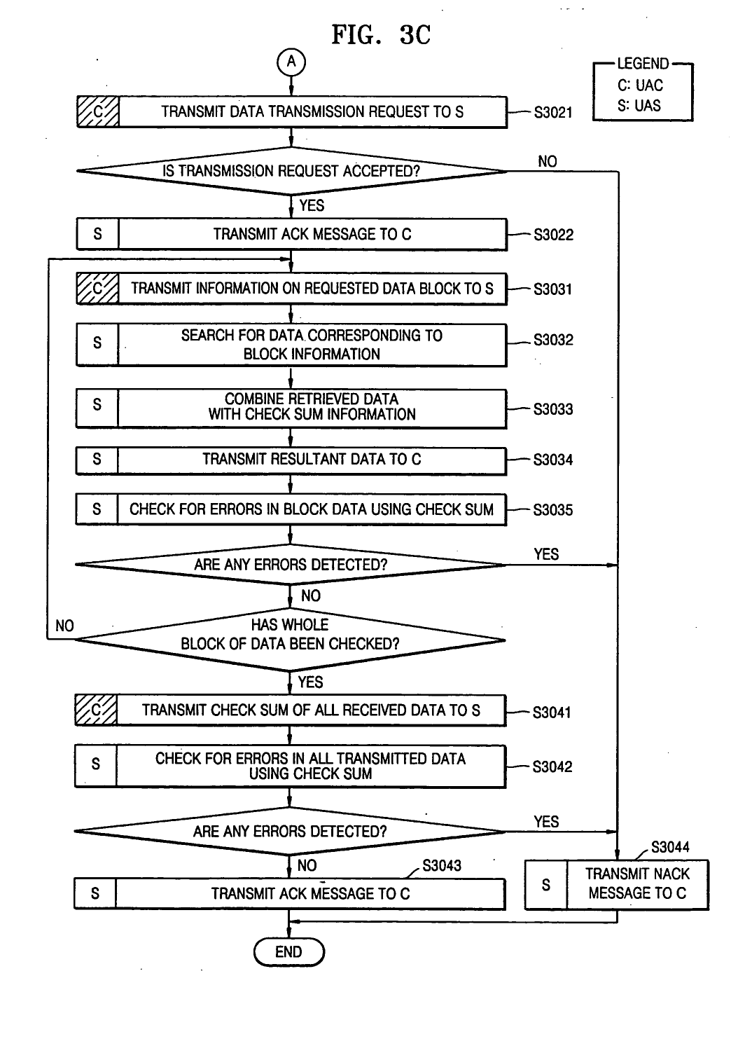

FIG. 2 is a flowchart illustrating a process for communicating data between a client and a server, according to the present invention. Referring to FIG. 2, to receive or transmit data between a client (UAC) 101 and a server (UAS) 102, a session is initialized using SIP (S21). A description of session initiation using SIP is omitted here (see RFC 2543 of the IETF) which is incorporated herein by reference. Through the generated SIP session, the client (UAC) 101 communicates desired data from/to the server (UAS) 102 using RDT messages (S22). Details of the communication process using RDT messages are provided later (with reference to FIGS. 3 through 7). After data communication is terminated, the session is ended using SIP (S23).

FIG. 3A is a flowchart illustrating a process for communicating random data. Referring to FIG. 3A, a process for communicating random data, according to the present embodiment, comprises requesting a server UAS for random data using an RDT message (S31), dividing the requested random data into blocks that are fundamental units of transmission, and communicating the random data (S32), and determining whether there is an error in the received data (S33). In this case, since it is possible to request a desired amount of data from the front of a desired block, this process is suited to communication of random data, rather than communication of sequential data stored at sequential addresses. Here, random data includes digital content, electronic documents, information related to electronic commerce, multimedia information, etc.

FIG. 3B is a communication diagram representing the process of communicating random data of FIG. 3A. Referring to FIG. 3B, if a session is initialized using SIP (S301), an SIP session is formed between a client (UAC) and a server (UAS), which allows direct P2P communication between the client (UAC) and the server (UAS). The process for communicating the random data comprises a data request step (S302), a data communication step (S303), and a data check step (S304).

In S302, (1) a data transmission request is sent to a server (UAS), and (2) response information for the data transmission request is received from the server (UAS). If the data transmission request is accepted, ACK is received. If the data request is not accepted, NACK is received.

In S303, the requested data is divided into blocks that are fundamental units of transmission, and then is communicated. In S303, (3) a block data transmission request is sent with block information, as information for a block, to the server (UAS), and (4) the requested block data and error correction information such as check sum are received, and it is determined through the error correction information whether there is an error in the received data. Steps (3) and (4) are repeated until it is determined that the requested data is completely received.

In S304, (5) summary error correction information that is a collection of all error correction information for the received block data is sent to the server (UAS), and (6) information indicating whether there are any errors in the received data is received from the server (UAS). If there is no error in the received data, information with ACK is received. If there is an error in the received data, information with NACK is received.

According to en exemplary embodiment of the present invention, it is determined whether blocks of data are correctly received using error correction information for each block in step (4). And, it is determined whether all of the data is correctly received using the summary error correction information for all of the data in steps (5) and (6).

According to the present embodiment, since two steps are performed to check twice whether data is correctly received by a client (UAC), stability and reliability of data communication are enhanced. SMS, being a unidirectional message service, cannot check whether received data is correct after the data is communicated. However, when data is communicated using a RDT message, as in the present invention, it is possible to check and double-check whether data is correctly received, thereby achieving data communication with higher stability and reliability.

Also, since a client can divide his/her requested data into blocks with a size and beginning location designated by the client, and then receive or transmit the divided block data, this method is suited to communication of random data.

FIG. 3C is a detailed flowchart illustrating a process for communicating random data. Referring to FIG. 3C, a client (UAC) sends a data transmission request to a server (UAS) (S3021), and the server (UAS) receives the data transmission request and transmits an ACK message to the client (UAC) in response to the data transmission request, if the server (UAS) accepts the transmission request (S3022).

Then, if the client (UAC) sends block information for the requested data to the server (UAS) (S3031), the server (UAS) searches for data corresponding to the block information (S3032), combines the data with error correction information (S3033), and transmits the resultant data to the client (UAC) (S3034). The client (UAC) determines, using the received error correction information, whether there is an error in the received block data (S3035). Data communication (steps S3031 through S3035) is repeated until it is determined that all of the requested data is received.

Finally, the client (UAC) collects error correction information for the received block data, calculates summary error correction information, and transmits the summary error correction information to the server (UAS) (S3041). The server (UAS) receives the summary error correction information and determines whether there are any errors in the received data (S3042). If there are no errors, the server (UAS) transmits an ACK message to the client (UAC) (S3043). If there is an error, the server (UAS) transmits an NACK message to the client (UAC) (S3044).

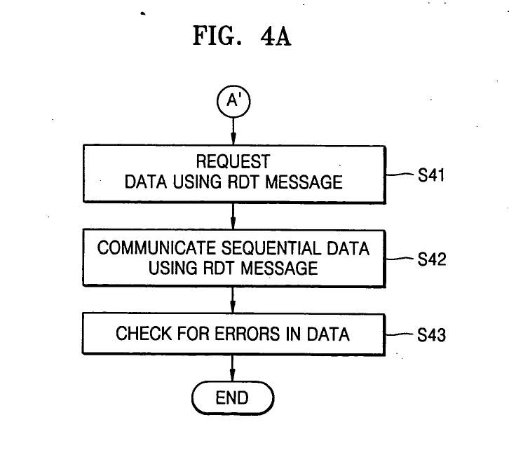

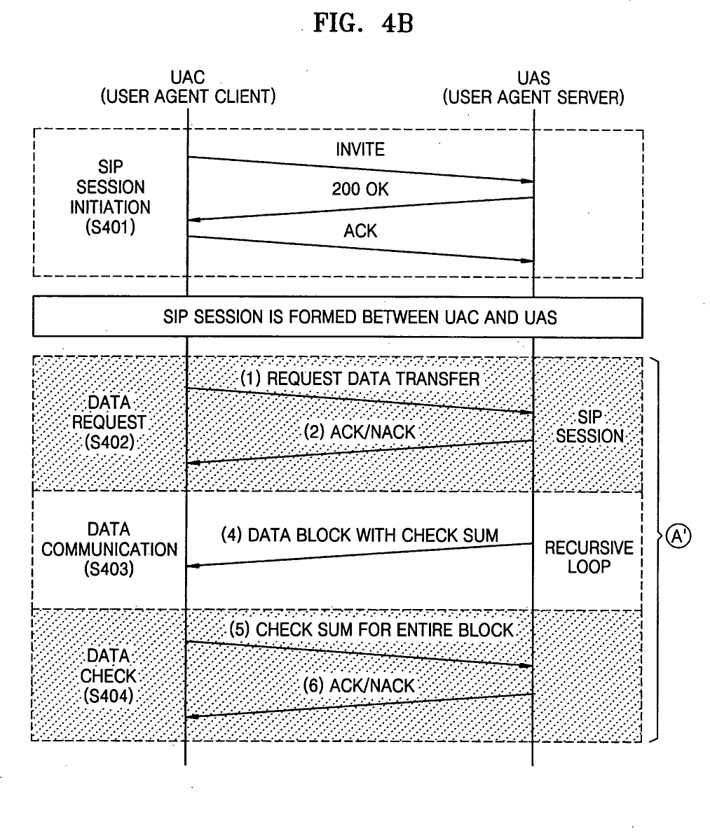

FIG. 4A is a flowchart illustrating a process for communicating sequential data. Referring to FIG. 4A, the process for communicating sequential data comprises requesting a server (UAS) for data using an RDT message (S41), dividing the requested data into blocks that are fundamental units of transmission and communicating the resultant data (S42), and determining whether there is an error in the received data (S43). Here, steps S41 and S43 are the same as steps S31 and S33 of the random data communication process of FIG. 3A, respectively; only S42 is different.

FIG. 4B is a communication diagram representing the process of FIG. 4A for communicating sequential data. A session initiation step using SIP (S401), a data request step (S402), and a data check step (S404) of the communication process shown in FIG. 4B are the same as in the above-described random data communication process of FIG. 3B. However, in a data communication step (S403), the communication process of FIG. 4B comprises only (4) receiving block data including error correction information from a server (UAS). That is, unlike the communication of random data, the communication process of FIG. 4B does not comprise (3) transmitting a block data transmission request with block information to the server (UAS) (S303 of FIG. 3B).

Accordingly, the communication process of FIG. 4B is suited to communication of sequential data. Also, the communication process of FIG. 4B is suited to communication of a large amount of data. Since process (3) of S303 is omitted, data can be transmitted at a higher rate than when transmitting random data.

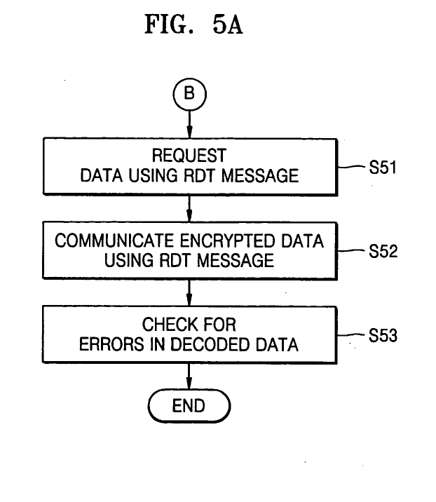

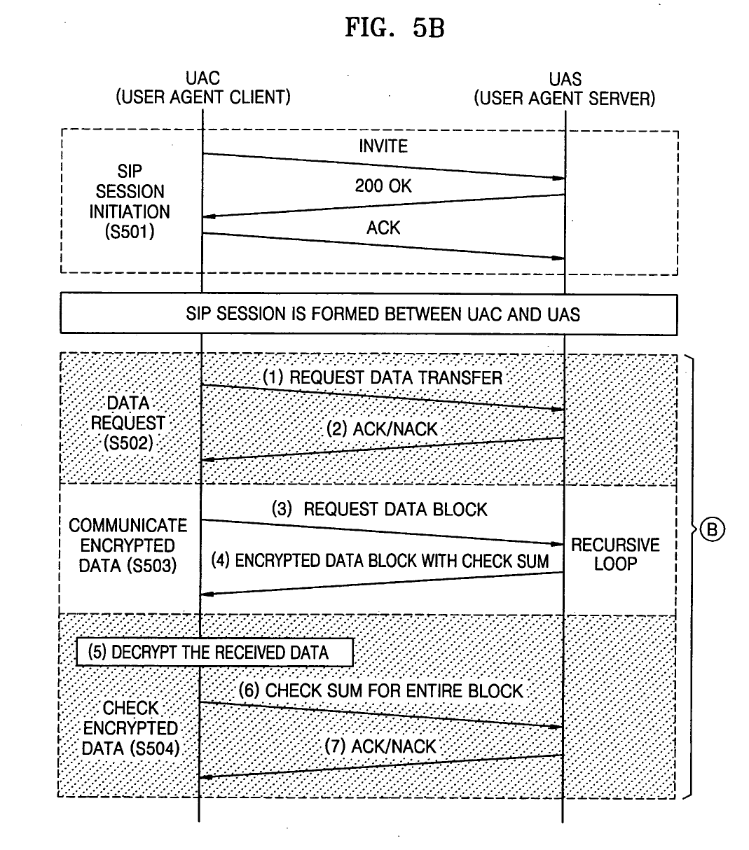

FIG. 5A is a flowchart illustrating a process for communicating encrypted data. Referring to 5a, the process for communicating encrypted data comprises requesting a server (UAS) for encrypted data using an RDT message (S51), dividing the requested encrypted data into blocks that are fundamental units of transmission and communicating the resultant encrypted data (S52), and decoding the encrypted data and determining whether there are any errors in the decoded data (S53).

FIG. 5B is a communication diagram representing the process of FIG. 5A for communicating encrypted data. Referring to FIG. 5B, the process for communicating encrypted data comprises a session initialization step using SIP (S501), a data request step (S502), an encrypted data communication step (S503), and a encrypted data check step (S504). Step S501 of initializing a session using SIP, and step (S502) of requesting data, are the same as in the process of FIG. 3B.

The data communication step (S503) comprises (4) receiving data encrypted as block data corresponding to block information. Encryption methods for encrypting the data include standardized encryption methods such as AES (Advanced Encryption Standard), DES (Data Encryption Standard), scrambling, and encryption methods which may be developed in future.

The data check step (S504) comprises (5) decoding received data before transmitting error correction information about all of the data.

Accordingly, by communicating encrypted block data and checking for errors in the received data twice, a data communication method with high stability and reliability can be implemented. Encryption can be applied in communicating random data or sequential data, thereby preventing illegal monitoring and fraud of data, and accordingly further increasing the reliability and safety of data communication.

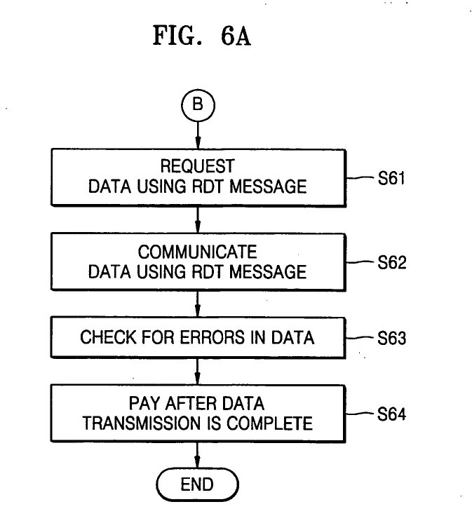

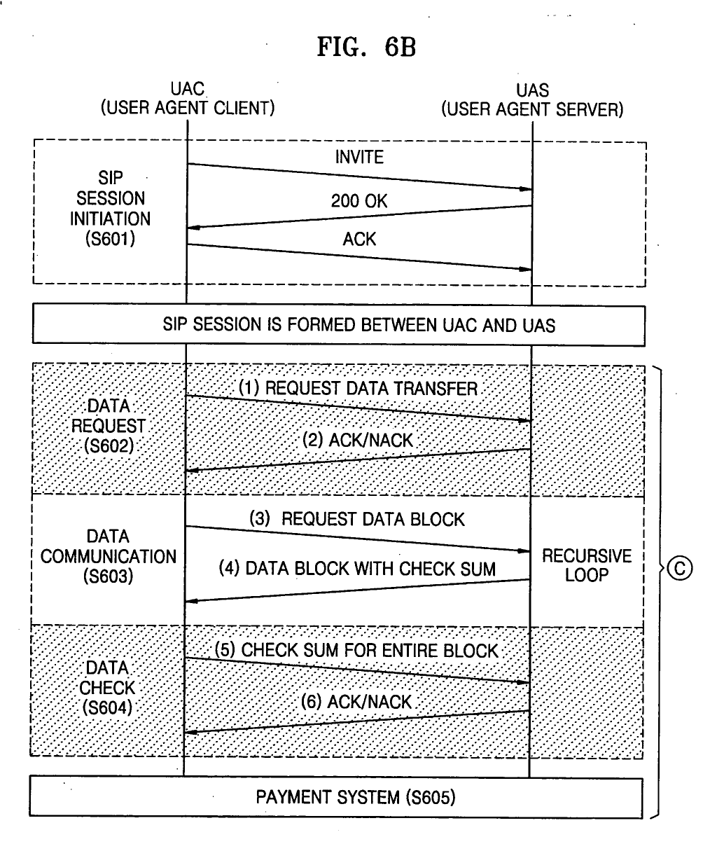

FIG. 6A is a flowchart illustrating a data communication process that further includes a payment step after communicating data. Referring to FIG. 6A, the data communication process comprises requesting a server (UAS) for data using an RDT message (S61), dividing the requested data into blocks that are fundamental units of transmission and communicating the resultant data (S62), checking whether there are any errors in the received data (S63), and paying after checking whether data transmission is complete (S64).

FIG. 6B is a communication diagram representing the process of FIG. 6B that further includes the payment step after communicating the data. Referring to FIG. 6B, the data communication process is the same as the process illustrated in FIG. 3B or 4B, except that the data communication process of FIG. 6B further comprises paying (S605) after checking whether data transmission is complete and whether received data is correct (S604).

Therefore, the problem of the conventional SMS service in which a user first pays a service-fee for data transmission and then does not receive the data properly due to some kind of communication disturbance can be solved. That is, since the service-fee is paid after it is checked that the data is received correctly and completely, a more reasonable electronic commerce method or system can be implemented.

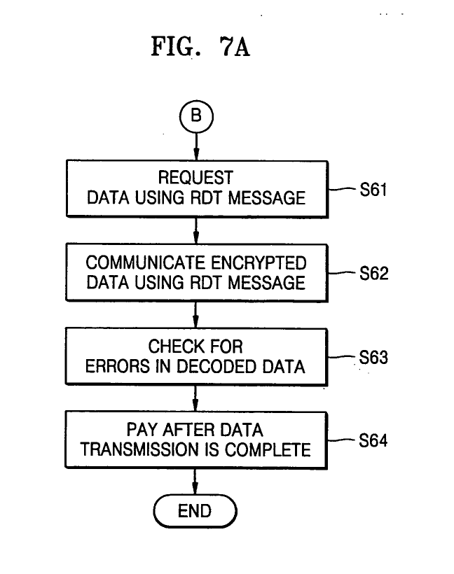

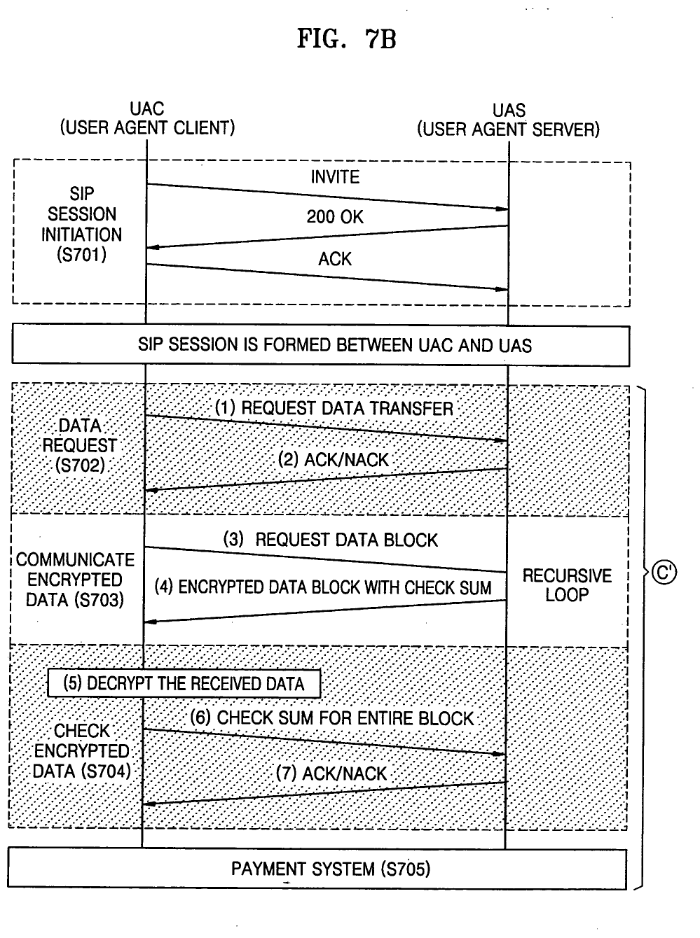

FIG. 7A is a flowchart illustrating a communication process the further includes a payment step after communicating encrypted data. Referring to FIG. 7A, the data communication process comprises requesting a server (UAS) for encrypted data using an RDT message (S71), dividing the requested encrypted data into blocks that are fundamental units of transmission and communicating the resultant data (S72), decoding the received encrypted data and checking whether there are any errors in the decoded data (S73), and paying after checking whether data transmission is complete (S74). Accordingly, data communication and service-fee payment are integrated, and encryption for security is maintained upon data communication.

FIG. 7B is a communication diagram representing the process of FIG. 7A that further includes the payment step after communicating the encrypted data. The data communication process of FIG. 7B is the same as the encrypted data communication process described above with reference to FIG. 5B, except that the data communication process of FIG. 7B further comprises paying (S705) after checking whether data transmission is complete and whether received data is correct (S704).

Therefore, the problem of conventional SMS service in which a user first pays a service-fee for data transmission and then does not properly receive the data due to some kind of communication disturbance can be solved. Also, it is possible to increase the reliability of data communication through encryption.

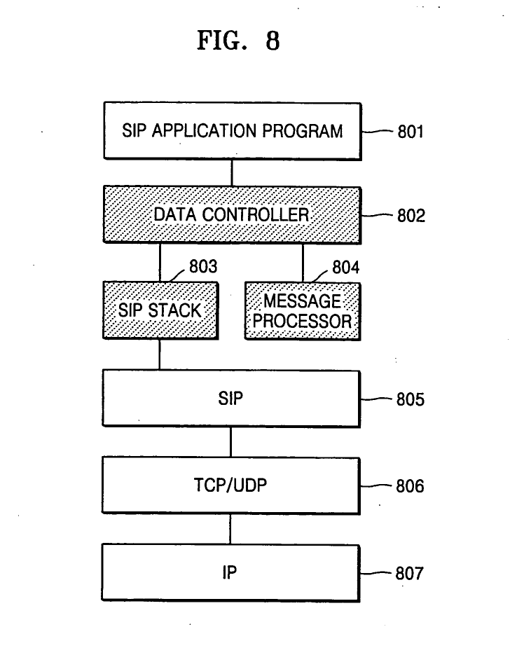

FIG. 8 is a conceptual scheme of an RDT message according to an OSI 7-layer model. Referring to FIG. 8, a client (UAC) or a server (UAS) according to the present invention includes a data controller 802, an SIP stack 803, and a message processor 804.

The SIP stack 803 communicates an RDT message as an expanded SIP (Session Initiation Protocol). That is, the SIP stack 803 transfers the RDT message to an SIP layer 805. Through SIP stack 803, an SIP Application Program can communicate with an SIP Application Program of corresponding terminal via a TCP/UDP layer 806 and an IP layer 807. Accordingly, the RDT message, as the expanded SIP, can be implemented independently for the TCP/UDT protocol or IP protocol as lower layer protocols.

The message processor 804 receives data from the data controller 802 and transforms the received data into an RDT message, or receives an RDT message from the data controller 802 and parses the received message to extract data.

The data controller 802 receives an RDT message from a corresponding terminal via the SIP stack 803 and transfers the received message to the message processor 804. The message is parsed in the message processor 804 so that data is extracted. The extracted data is transferred to an SIP application program 801 via the data controller 802. Also, the data controller 802 receives data from the SIP application program 801 and transfers the data to the message processor 804. The data is transformed into an RDT message in the message processor 804 and the RDT message is transmitted to the corresponding terminal through the SIP stack 803.

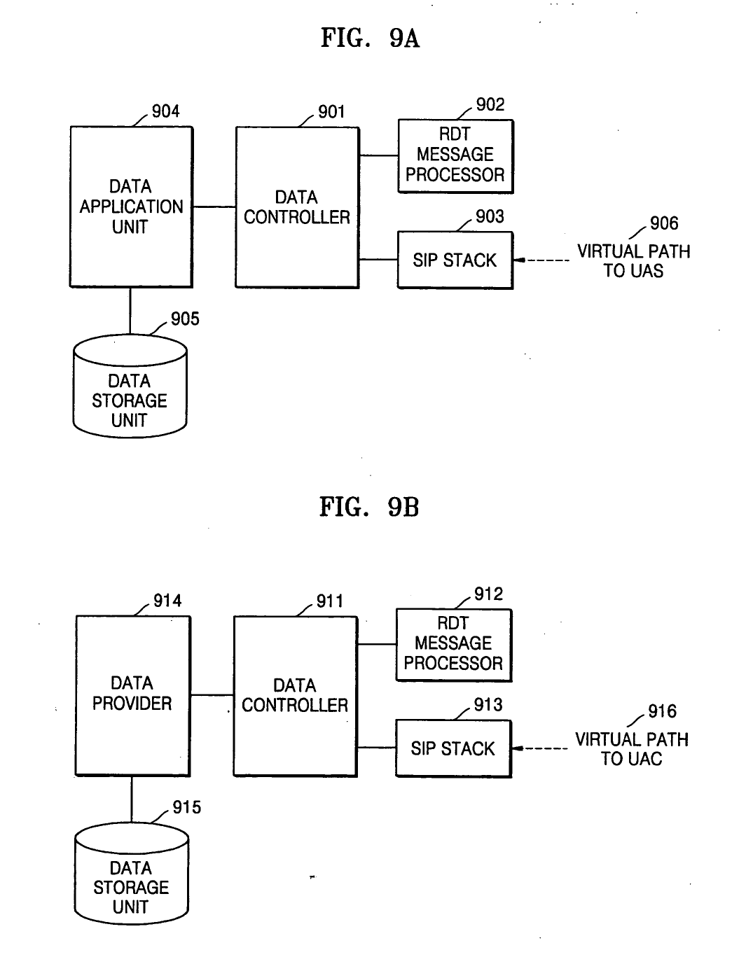

FIG. 9A is a block diagram of a client (UAC) according to an exemplary embodiment of the present invention. Referring to FIG. 9A, the client (UAC) comprises an RDT message processor 902, an SIP stack 903, a data application unit 904, and a data controller 901.

The RDT message processor 902 transforms information for requested data from a server (UAS) into an RDT message, and parses an RDT message received from a server (UAS) to extract requested data.

The SIP stack 903 receives an SIP protocol message including an RDT message from the server (UAS), and transmits an SIP protocol message including an RDT message to the server (UAS).

The data application unit 904 receives data extracted by the RDT message processor 902, and processes the received data or stores the data in a data storage unit 905. The data application unit 904 receives data from the server (UAS), which performs functions such as electronic commerce, contents distribution, Data-warehousing, and electronic documents management, and can process the data in various ways such as storing the data in the data storage unit 905 or displaying the data on a screen.

The data controller 901 sends information on requested data from the server (UAS) to the RDT message processor 902, and transfers an RDT message processed by the RDT message processor 902 to the SIP stack 903. In addition, the data controller 901 sends an RDT message received through the SIP stack 903 to the RDT message processor 902, and transfers information on data parsed and extracted by the RDT message processor 902 to the data application unit 904. Here, the information on requested data may include information such as a data ID, a path, a size of a fundamental data block, or a start location of a data block, and the information on data parsed and extracted by the RDT message processor 902 may include information such as a start location of a data block, a block size, a data block, or a check sum.

FIG. 9B is a block diagram of a server (UAS) according to an exemplary embodiment of the present invention. Referring to FIG. 9B, the server (UAS) comprises an RDT message processor 912, an SIP stack 913, a data provider 914, and a data controller 911.

The RDT message processor 912 parses an RDT message received from a client (UAC) and extracts information on requested data, and transforms information on requested data to be transmitted to the client (UAC) into an RDT message.

The SIP stack 913 receives an SIP protocol message including an RDT message from the client (UAC), and transmits an SIP protocol message including an RDT message to the client (UAC).

The data provider 914 searches for data corresponding to the information on requested data and provides the data to the data controller. The data provider 914, as part of a server (UAS) that performs functions such as electronic commerce, contents distribution, Data-warehousing, and electronic documents management, searches for various data and can process the data in various ways such as storing the data in the data storage unit 915 or displaying the data on a screen.

The data controller 911 sends an RDT message received through the SIP stack 913 to the RDT message processor 912, and transfers information on data parsed and extracted by the RDT message processor 912 to the data provider 914. In addition, the data controller 911 sends information on requested data received from the data provider 914 to the RDT message processor 912, and transfers a transformed RDT message to the SIP stack 913. Here, the information on requested data may include information such as Data Identification, path, a size of fundamental data block, or a start location of a data block, etc. Also, the information on requested data to transfer to the client (UAC) may include information such as a start location of a data block, a size of block, a data block, or check sum, etc.

FIG. 10B is a diagram of a conceptual configuration of an RDT message according to an embodiment of the present invention. Referring to FIG. 10A, an SIP message includes an SIP header part 1001 and an SIP body part 1002. The RDT message is an expanded SIP and can increase the reliability of data transmission.

The SIP header part 1001 includes information required for session initiation, such as a sender address, a receiver address, a proxy server address (UAS), a CALL-ID, a number of messages, a type of contents, and a length of contents.

The SIP body part 1002 includes information for a function to be performed through a set session. An RDT message for reliable data communication according to the present invention is included in the SIP body part 1002. In particular, the SIP body part 1002 includes, as an RDT message, a command 1003 indicating a command type to be executed and at least one parameter 1004 with information required for executing the command.

The RDT message is an expanded body part of SIP and has the all advantages of SIP, i.e., user mobility, minimal state maintenance, and independence for lower layer protocols. Also, the RDT message is a text-based protocol like HTTP.

FIG. 10B is a view showing detailed configurations of RDT messages according to embodiments of the present invention. Referring to FIG. 10B, the RDT messages shown in (1) through (6) each consists of a command and at least one parameter. As an example, an RDT message used in the data communication process of FIG. 3B will be described below.

AN RDT message (1) is used by a client (UAC) for requesting a server (UAS) for data transmission. A command 1011 includes a data transmission request and a parameter includes information 1022 on requested data. The parameter can include information 1022 on requested data or information 1023 on the size of a data block that is a fundamental unit of transmission. For example, the parameter may include a file name, a path, a block size, etc.

An RDT message (2) represents information sent from the server (UAS) in response to the data transmission request. A command 1031 includes a command to receive the response of the server (UAS) to the transmission request and a parameter includes response information 1032 indicating whether the transmission request is accepted. The response information 1032 includes ACK if the server (UAS) accepts data transmission and includes NACK if the server (UAS) does not accept data transmission.

An RDT message (3) is used by a client (UAC) for requesting transmission of data blocks to the server (UAS). This message is used in the communication of random data, but it can be omitted in the communication of sequential data. A command 1041 includes a command to transmit block information on requested data from the server (UAS) and a parameter includes information 1042 through 1044 on blocks that are fundamental units of transmission. The parameter can include a data path and file name 1042, a data block start location 1043, a data block size 1044, etc.

An RDT message (4) is for receiving data for a block requested by the server (UAS). The server (UAS) receives data of a requested block from the data provider and sends the data together with error correction information to the client (UAC). A command 1051 includes a command to receive block data corresponding to transmitted block information and error correction information from the server (UAS), and a parameter includes block data 1052 through 1056 received from the server (UAS). The parameter can include a data path and file name 1052, a data block start location 1053, a data block size 1054, a data block 1055, or error correction information 1056. Here, the data block 1055 is applicable in various formats including text data, binary data, and a user-defined data format using an encoding format such as BASE64. If binary data is used instead of text data, it is possible to increase an amount of data transmission for each fundamental block and increase a transmission rate. This is because text data represents information of one character using two bytes, while binary data represents the same information using only one byte.

An RDT message (5) is for transmitting error correction information for all received data to the server (UAS). A command 1061 includes a command for transmitting summary error correction information, which is a collection of error correction information of the received data blocks, to the server (UAS), and parameters 1062 through 1064 include a data path and file name 1062, a total data size 1063, and error correction information 1064. Accordingly, it is possible to check for errors in all received blocks at once, as well as in individual blocks, on a block-by-block basis. This enhances the reliability of transmitted data.

An RDT message (6) is for receiving information on the existence of errors in data checked by the server (UAS). A command 1071 includes a command to receive information on the existence of errors in data checked using the received error correction information, from the server (UAS), and a parameter includes information 1072 on the existence of errors. If it is determined using the error correction information for all data that there are no errors in the received data, a NACK message is received. If there is an error in the received data, an ACK message is received.

The above-described configurations of RDT messages can be realized in various ways. FIGS. 11A and 11B show actual RTD messages according to exemplary embodiments of the present invention. Referring to FIG. 11A, “<command>request_data</command>” 1071 is used as a command 1011 or 1021 for requesting the server (UAS) for data. A path “<path>/home/kurapa/</path>” 1073 located between “<data>” and “</data>”, and a file name “<filename>kurapa_resume.doc</filename>” 1074 is used as information 1012 or 1022 on requested data. Also, “<block_size>1024</block_size>” is used as information 1023 on a size of a data block that is a fundamental unit of transmission. This message represents a request to divide data with a file name of “kurapa_resume.doc” on the path of “/home/kurapa/” into blocks of 1024 bytes and transmit the resultant block data.

FIG. 11B shows an example of the RDT message (4) of FIG. 10B. Referring to FIG. 11B, “<command>send_data</command>” 1082 is used as a command 1051 to receive requested data from the server (UAS). In addition, the RDT message includes a path 1082, a file name 1083, a data block start location 1084, a block size 1024, and requested block data 1086. The block data 1086 is applicable in various formats including text data, binary data, or a user-defined format using an encoding format such as BASE64.

Code such as “request_data” and “send_data” has been used in the above description to provide concrete examples. However, the RDT messages of the present invention may be written in various ways, and may have various formats, according to desired functions. The RDT message may have an HTTP format according to SIP.

As described above, the present invention provides a method for communicating data between a client and a server using RDT messages as an expanded SIP, a recording medium, a system, a client (UAC), and a server (UAS). The present invention makes it possible to stably and reliably receive or transmit data between a client and a server. Also, the present invention solves a problem of conventional SMS service in which a user first pays a service-fee for data transmission and then does not receive the data properly due to a communication disturbance.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for communicating data between a client and a server, the method comprising:
(a) initializing a communication session using Session Initiation Protocol (SIP);
(b) requesting server data using a Reliable Data Transfer (RDT) message as an expanded SIP, receiving data, and checking whether the data is correctly received; and
(c) terminating the communication session using SIP.

2. The method of claim 1, wherein step (b) comprises:
(b1) receiving random data, sequential data, or encrypted data.

3. The method of claim 2, wherein step (b) further comprises:
(b2) paying if all requested data is received and there are no errors in the received data.

4. The method of claim 2, wherein step (b1) comprises:
(b1-1) transmitting a data transmission request including information on requested data to the server; and
(b1-2) receiving a response from the server indicating whether the data transmission request is accepted.

5. The method of claim 4, wherein step (b1) further comprises:
(b1-3) transmitting information on a block, which is a unit of transmission data, of requested data to the server; and
(b1-4) receiving block data corresponding to the information on the block together with error correction information from the server; and
(b1-5) checking for errors in the received block data using the received error correction information,
wherein steps (b1-3) through (b1-5) are repeated until the requested data is all received.

6. The method of claim 5, wherein step (b1) further comprises:
(b1-6) transmitting summary error correction information for received block data to the server; and
(b1-7) receiving information on the existence of errors in data checked using the summary error correction information, from the server.

7. The method of claim 5, wherein step (b1-4) further comprises receiving encrypted block data using any one among Advanced Encryption Standard (AES), Data Encryption Standard (DES), and scrambling.

8. The method of claim 6, wherein step (b1-6) further comprises decoding received encrypted block data using any one among Advanced Encryption Standard (AES), Data Encryption Standard (DES), and scrambling, before transmitting the summary error correction information.

9. A computer readable medium having embodied thereon a computer program for the data communication method of any one of claims 1 through 8.

10. A computer readable medium comprising:
a Session Initiation Protocol (SIP) message, which includes an SIP header part for initializing a session and an SIP body part capable of performing a desired function through a set session; and
an RDT message, which includes a command representing a type of a command to be executed and at least one parameter with information for executing the command, and is included in the SIP body part.

11. The computer readable medium of claim 10, wherein the command includes a data transmission request, and the parameter includes information on requested data.

12. The computer readable medium of claim 11, wherein the parameter further includes information on a size of a data block that is a fundamental unit of transmission.

13. The computer readable medium of claim 10, wherein the command includes a command to receive a response from the server to a transmission request, and
the parameter includes response information indicating whether the transmission request is accepted.

14. The computer readable medium of claim 13, wherein the parameter includes ACK or NACK as response information.

15. The computer readable medium of claim 10, wherein the command includes a command to transmit block information on requested data to the server, and
the parameter includes information on any one among a data path and file name, a start location of a data block, and a size of a data block.

16. The computer readable medium of claim 10, wherein the command includes a command to receive block data corresponding to transmitted block information, and error correction information, from the server, and the parameter includes information on any one among a data path and file name, a start location of a data block, a size of a data block, a data block, and error correction information.

17. The computer readable medium of claim 15, wherein the data block is text data, binary data, or encoded data with a user-defined format.

18. The computer readable medium of claim 10, wherein the command includes a command to transmit summary error correction information on received data to the server, and
the parameter includes information on any one among a data path and file name, a total size of data, and error correction information.

19. The computer readable medium of claim 10, wherein the command includes a command to receive information on the existence of errors in data checked using the transmitted error correction information, from the server, and
the parameter includes information on the existence of errors.

20. The computer readable medium of claim 18, wherein the parameter includes ACK or NACK as information on the existence of errors.

21. A system for communicating data between a client and a server, the system comprising:
a user agent client (UAC), operable to request desired data using a Reliable Data Transfer (RDT) message as an expanded Session Initiation Protocol (SIP) and check whether the data is correctly received; and
a user agent server (UAS), operable to combine the requested data with information indicating whether the data is correctly transmitted, using the RDT message as the expanded SIP, and transmit the resultant data.

22. A user agent client (UAC) which requests a server for data, the client comprising:
a Reliable Data Transfer (RDT) message processor operable to convert information on requested data into an RDT message and extract the requested data from a received RDT message;
a Session Initiation Protocol (SIP) stack operable to communicate an SIP message including an RDT message between the server;
a data application unit operable to process or store the extracted data; and
a data controller, operable to send information on requested data to the RDT message processor and transfer a transformed RDT message to the SIP stack, and send an RDT message received from the SIP stack to the RDT message processor and transfer information on the extracted data to the data application unit.

23. The user agent client of claim 22, wherein the user agent client is any one among an Internet phone, a PDA, a mobile phone, and a PC.

24. A user agent server (UAS) which provides data to a client, the server comprising:
a Reliable Data Transfer (RDT) message processor operable to extract information on requested data from a received RDT message, and transform the information on requested data into an RDT message;
a Session Initiation Protocol (SIP) stack operable to communicate an SIP message including an RDT message between the client;
a data provider operable to provide data corresponding to the information on requested data to a data controller; and
a data controller, operable to send an RDT message received from the SIP stack to the RDT message processor and transfer information for the extracted data to the RDT message processor, and send information on data received from the data provider to the data provider and transfer a transformed RDT message to the SIP stack.

25. The user agent server of claim 24, wherein the user agent server (UAS) performs at least one function among electronic commerce, contents distribution, Data-warehousing, and electronic documents management.
